(19) United States
(12) Patent Application Publication
(10) Pub. No.: US 2006/0166097 A1
(43) Pub. Date: Jul. 27, 2006

(54) Thermal battery

(75) Inventor: Syozo Fujiwara, Neyagawa-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO.,LTD., Osaka (JP)

(21) Appl. No.: 11/338,756

(22) Filed: Jan. 25, 2006

(30) Foreign Application Priority Data
Jan. 26, 2005 (JP) 2005-018066

(51) Int. Cl. H01M 4/58; H01M 6/36

(52) U.S. Cl. 429/231.95; 429/112; 429/224; 429/221; 429/220; 429/223

(57) ABSTRACT

A thermal battery includes a plurality of unit cells. Each unit cell includes a cathode, an anode, and an electrolyte disposed between the cathode and the anode. The electrolyte comprises a salt molten at the thermal battery operating temperatures. The anode includes a lithium-containing composite nitride as an active material.

### BACKGROUND OF THE INVENTION

Generally, a thermal battery includes a plurality of unit cells. Each unit cell comprises an anode, a cathode, and an electrolyte interposed between the anode and the cathode. For the electrolyte, a salt molten at high temperatures is employed. At ambient temperature, this electrolyte is not ion-conductive, and therefore the thermal battery is in inactive state. When heat is applied to the unit cell to give high temperatures, the electrolyte will be in molten state and becomes an excellent ion-conductor, thereby bringing the thermal battery into active state and enabling a supply of electricity to the outside electric devices.

Thermal battery is a kind of reserve battery. The battery reaction is not advanced unless the electrolyte melts. Thus, even after 5 to 10 years or more of storage, the battery performance same as the performance right after its manufacture can be achieved. The electrode reaction of the thermal battery advances at high temperatures. Thus, the electrode reactions advance far more rapidly compared with other batteries using an aqueous solution electrolyte, an organic electrolyte, and the like. Therefore, thermal batteries have excellent discharge characteristics under high load. Further, thermal batteries are advantageous in that electricity becomes available in a short period of time, within a second, when an activation signal is sent to the battery at usage, though the period of time varies depending upon the heating method. Thus, based on these advantageous characteristics, thermal batteries are suitably used as a power source for various ordnance devices such as a guidance system, or as an emergency power source.

To improve these characteristics, researches have been conducted for thermal batteries using lithium for an anode active material. For example, a usage of a lithium metal, or a lithium alloy comprising a lithium metal and other metals for the anode active material has been examined.

Lithium metals have a low melting point (181° C.) than the electrolyte. Therefore, lithium metals are liquefied completely under the range of general operating temperatures for thermal batteries (400 to 600° C.) and the melted lithium may leak out from the anode, which may reach the cathode to cause a short circuit. Therefore, a technology is needed for immobilizing lithium. For the lithium immobilization method, there has been proposed to retain lithium by metal powders such as iron powders to form the anode, for example (see Japanese Laid-open Patent Publication No. Sho 61-230263, for example).

For the preparation of the anode in which a lithium alloy is used for the anode active material, there has been proposed to mix lithium alloy powders with metal powders and then to pressure-mold the mixture, aiming to improve moldability and strength of the anode. Also, aiming to improve capacity, there has been proposed to mix lithium alloy powders with a salt mixture of a eutectic composition (hereinafter, referred to as a eutectic salt)(see Japanese Laid-open Patent Publication No. Hei 6-203844, for example).

However, when lithium metal is to be used, a retainer for lithium metal has to be added as mentioned in the above, and the amount of lithium metal will decrease by the amount of the added retainer, thereby decreasing the capacity of anode. Additionally, lithium metal itself has many handling and facility restrictions. In some cases, complicated steps, such as melting the lithium metal, are necessary.

Also, when a lithium alloy is to be used, metal powders and a salt have to be added as mentioned in the above, and the amount of lithium alloy will decrease by the amount of the added metal powders and salt, thereby decreasing the capacity of anode. Additionally, lithium alloy itself is poor in workability.

Further, under the high operating temperature range of 400 to 600° C., it is difficult to reliably prevent the leakage of lithium from the anode, even though the retainer is added to the lithium metal as noted in the above. Also, even metal powders or the salt is added to lithium alloy as noted above, it is difficult to reliably prevent an occurrence of fractures and cracks of anode.

In preparation of thermal batteries, the preparation works are carried out in dry air to prevent the active material including lithium from contacting moisture. However, when nitrogen exists in the dry air, nitrogen reacts with the lithium metal to naturally form an electrochemically inactive compound containing nitrogen (Li₃N and the like). Thus, the working environment has to be established and managed with further restrictions so as to prevent the formation of such compound containing nitrogen. Especially, in order to obtain excellent discharge characteristics under high load, this is the key point.

In non-aqueous electrolyte secondary batteries, there has been proposed to use a lithium-containing composite nitride represented by the general formula: LiₐM_{b}N (In the formula, M is a transition metal, and “a” is the lithium content in the active material. The value changes with charge and discharge.) for the anode active material, to improve charge and discharge cycle characteristics (see, Japanese Patent No. 3277631, for example). However, in thermal batteries, from the reasons noted above, so far, the usage of a compound containing nitrogen and lithium for an active material has not been considered in view of the improvement of discharge characteristics under high load.

Thus, to solve the above conventional problems, the present invention aims to provide a highly reliable thermal battery excellent in discharge characteristics under high load, by improving moldability, chemical stability, and reactivity of anode, while maintaining a high capacity.

### BRIEF SUMMARY OF THE INVENTION

The present invention is directed to a thermal battery including a plurality of unit cells. Each unit cell comprises a cathode, an anode, and an electrolyte interposed between the cathode and the anode. The electrolyte comprises a salt molten at the thermal battery operating temperatures. The anode comprises a lithium-containing composite nitride as an active material.

The lithium-containing composite nitride is preferably a compound represented by the general formula:
Li_{3-x-y}MₓN,

where M is at least one selected from the group consisting of Co, Ni, Cu, Mn, and Fe, and “x” and “y” satisfy 0.1≦x≦0.8 and 0≦y≦2-x, respectively.

The anode preferably further includes at least one selected from the group consisting of iron, copper, nickel, manganese, and a carbon material.

The anode preferably further includes a salt molten at the thermal battery operating temperatures.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a perspective view showing partially cutaway cross sections of a thermal battery of an embodiment of the present invention.

FIG. 2 is an exploded cross sectional view of a unit cell used in the thermal battery in FIG. 1.

FIG. 3 is a vertical cross section of an anode used in the unit cell of Comparative Example 1.

FIG. 4 is a vertical cross section of an anode used in the unit cell of Comparative Example 4.

### DETAILED DESCRIPTION OF THE INVENTION

The present invention relates to a thermal battery including a plurality of unit cells, each of which comprising a cathode, an anode, and an electrolyte disposed between the cathode and the anode, the electrolyte comprising a salt molten at the thermal battery operating temperatures (a molten salt). In other words, the electrolyte is inactive at ambient temperature but is activated by melting at a predetermined temperature when the thermal battery is operated. The thermal battery is characterized in that the anode includes a lithium-containing composite nitride as an active material.

By using the lithium-containing composite nitride for the anode active material, as noted above, moldability, chemical stability, and reactivity at discharge of anode are improved, while achieving a high capacity, thereby a highly reliable thermal battery with excellent discharge characteristics, especially discharge characteristics under high load can be obtained.

The lithium-containing composite nitride is, for example, a compound represented by the general formula:
Li_{3-x-y}MₓN,
in which a part of Li in Li₃N is substituted by a transition element M.

Preferably, M is at least one transition element selected from the group consisting of Co, Ni, Cu, Mn, and Fe, and “x” and “y” satisfy 0.1≦x≦0.8 and 0≦y≦2-x, respectively.

Herein, “x” represents the amount of the transition element M substituted for Li. “y” represents deviation from the stoichiometric composition. The compound is the stoichiometric composition when y=0, and the value of “y” increases as discharge progresses. Therefore, when 0<y, the formula represents the compound during discharge.

When x<0.1, the anode capacity decreases. When 0.8<x, the lithium-containing composite nitride comprising a single phase cannot be obtained. When 2-x<y, the anode potential exceeds 1.5 V vs. Li/Li+ to drop the battery voltage, thereby failing to obtain sufficient discharge characteristics.

For the element M, Co is particularly preferable in that a high capacity can be obtained. Preferably, “x” is 0.2 to 0.6, because the plateau of the discharge voltage can be maintained, based on an improvement of crystallinity and the like. Further preferably, “y” is 0.8 to 1.9, because a high capacity can be obtained.

The above lithium-containing composite nitride can be obtained by mixing predetermined amounts of lithium nitride (Li₃N) powders as a starting material and powders of transition metal M for the substitution material, and baking the mixture in a high-purity nitrogen atmosphere, for example.

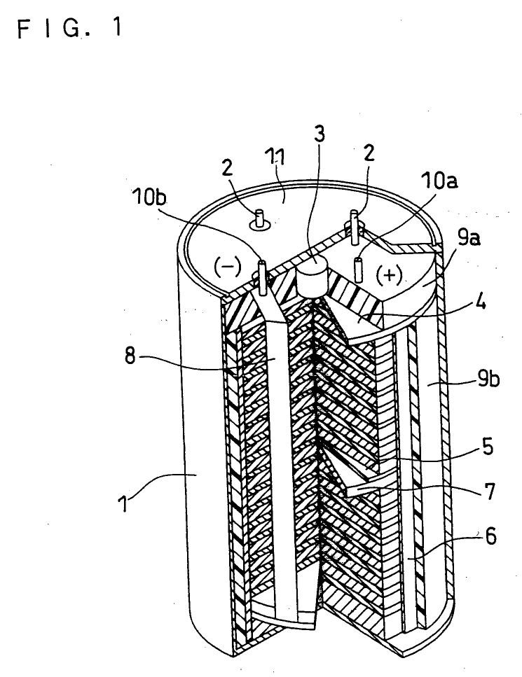

Herein, an embodiment of a thermal battery of the present invention is described by referring to FIG. 1.

In FIG. 1, a power-generating portion, in which a plurality of unit cells 7 and heating agents 5 are alternately stacked, is stored in a metal-made outer case 1. On top of the power-generating portion, an ignition pad 4 is disposed, and in the proximity of the top of the ignition pad 4, an igniter 3 is disposed. Along the side wall of the power-generating portion, a fuse wrap 6 is disposed. The heating agent 5 includes iron powders and is conductive. Thus, the unit cells 7 are electrically connected in series via the heating agents 5. The heating agent 5 comprises a mixture of Fe and KClO₄, for example, and since Fe powders are sintered at the time of the battery activation along with the combustion of the heating agent 5, the conductivity of the heating agent 5 is maintained, from the start of discharging (the start of combustion) to the termination of discharging (the termination of combustion).

The outer case 1 is sealed by a battery lid 11 having a pair of ignition terminals 2, a positive terminal 10a, and a negative terminal 10b. The positive terminal 10a is connected to the uppermost cathode of the unit cell 7 in the power-generating portion, via a cathode lead plate. On the other hand, the negative terminal 10b is connected to the lowermost anode of the unit cell 7 in the power-generating portion, via an anode lead plate 8. Between the battery lid 11 and the ignition pad 4, a thermal insulating material 9a is disposed, and between the outer case 1 and the power-generating portion, a thermal insulating material 9b is filled.

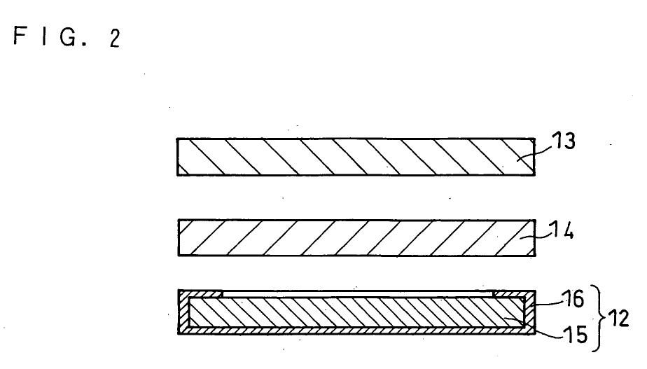

As shown in FIG. 2, the unit cell 7 comprises an anode 12, a cathode 13, and an electrolyte 14 disposed between the anode 12 and the cathode 13.

The anode 12 comprises an anode material mixture layer 15 including a lithium-containing composite nitride as an anode active material, and an iron-made cup-like current collector 16 housing the anode material mixture layer 15, as shown in FIG. 2. The anode material mixture layer 15 has a high capacity, while being chemically stable, and includes the above anode active material excellent in reactivity. Thus, moldability of the anode material mixture layer 15 is improved, and a capacity during discharge under high load is greatly increased.

The anode material mixture layer 15 preferably includes iron, copper, nickel, manganese, a carbon material, or a mixture thereof as a conductive material, to improve electron conductivity of the anode material mixture layer 15. The conductive material content in the anode material mixture layer 15 is preferably 1 to 10 wt %, so that electron conductivity of the anode material mixture layer 15 sufficiently improves, without decreasing the capacity of the anode 12.

The anode material mixture layer 15 preferably includes a salt to be used in the electrolyte 14, mentioned later, to improve ion conductivity of the anode material mixture layer 15. The salt content in the anode material mixture layer 15 is preferably 1 to 25 wt %, so that ion conductivity of the anode material mixture layer 15 sufficiently improves, without decreasing the capacity of the anode 12.

The cathode 13 comprises a mixture of a cathode active material such as FeS₂, MnO₂, or V₂O₅, and an electrolyte to be used in the electrolyte 14, mentioned later.

The electrolyte 14 comprises a mixture of a salt molten at the thermal battery operating temperatures (high temperatures), and a retainer such as MgO, for example. Any salt usable for a thermal battery, such as an alkaline metal salt, a mixture of salts, or a eutectic salt may be used. For example, an alkaline metal salt such as LiCl or KCl, or a eutectic salt such as LiCl—KCl, LiCl—LiBr—LiF, LiCl—LiBr—KBr, or LiNO₃—KNO₃ may be used.

The above conductive material and salt may be used alone or in combination, considering load current and moldability of the anode material mixture layer 15.

The anode material mixture layer 15 can be obtained by pressure-molding the lithium-containing composite nitride powders, for example. To increase strength of the molded anode material mixture layer 15, the above conductive material powders and the like may be added to the lithium-containing composite nitride powders at the time of pressure-molding.

The operation of the above thermal battery is described below.

From a power source connected to the ignition terminal 2, a high voltage is applied to the ignition terminal 2 to fire the igniter 3. The combustion is transferred to the ignition pad 4 and a fuse wrap 6, to combust the heating agent 5 to heat the unit cell 7. Then, the electrolyte 14 of the unit cell 7 melts to become a molten salt, i.e. an ion-conductor. The battery is thus activated to enable discharge.

Although an internally-heated thermal battery, in which an igniter is provided inside of the battery and the battery is activated by heating the power-generating portion from inside of the battery, is described in the above, the present invention can be applied to an externally-heated thermal battery as well, in which an igniter is not provided inside of the battery and the battery is activated by heating the power-generating portion with a heater such as a burner from outside of the battery.

Although Examples of the present invention are described in detail in the following, the present invention is not limited to these Examples.

### EXAMPLE 1

A unit cell shown in FIG. 2 was prepared as described below.

(1) Preparation of Anode

Li₃N powders and Co powders were mixed so that the atomic ratio of Li and Co satisfies 2.6:0.4. Then, the mixture is baked for 8 hours at 700° C. under a high-purity nitrogen atmosphere (99.9% or more), to obtain a baked product of Li_{2.6}Co_{0.4}N. After grinding the obtained baked product by using a ball mill and the like, the ground baked product was sieved to obtain Li_{2.6}Co_{0.4}N powders with a mesh size of 100 or below.

The Li_{2.6}Co_{0.4}N powders obtained by the above method as an anode active material were pressure-molded with a pressure of 2 tons/cm², to give a disk form with a diameter of 24 mm and a thickness of 0.7 mm, to obtain an anode material mixture layer 15. Then, the anode material mixture layer 15 was placed in a cup-like current collector 16 made of stainless steel SUS308. Opening end of the current collector 16 was bent inwardly to crimp a peripheral portion of the anode material mixture layer 15, thereby clamping the anode material mixture layer 15 between the bent portion and the bottom portion of the current collector 16. The anode material mixture layer 15 is thus fixed inside the current collector 16, to obtain the disk-like anode 12 with a diameter of 26 mm and a thickness of 1.2 mm.

(2) Preparation of Unit Cell

A unit cell 7 was obtained by stacking the anode 12 obtained above with a cathode 13 interposing an electrolyte 14 therebetween.

The electrolyte 14 was obtained by mixing LiCl—KCl as a eutectic salt and MgO as a retainer with a weight ratio of 60:40, and by pressure-molding the obtained mixture with a pressure of 2 tons/cm² to give a disk form with a diameter of 26 mm and a thickness of 0.4 mm.

The cathode 13 was obtained by mixing FeS₂ powders as a cathode active material, LiCl—KCl as a eutectic salt, and silica powders with a weight ratio of 70:20:10, and by pressure-molding the obtained mixture with a pressure of 2 tons/cm² to give a disk form with a diameter of 26 mm and a thickness of 0.4 mm.

At this time, to compare anode performance, the amount of the cathode active material and the amount of the anode active material were adjusted so that the cathode capacity is larger than the anode capacity.

Preparation of the unit cell as described above was carried out in an environment of dry air with the dew point of −45° C. or below, where influences from moisture were eliminated to the maximum. Also, when handling the lithium-containing composite nitride, the preparation was carried out under a high-purity nitrogen atmosphere (99.9% or more), as necessary.

### EXAMPLE 2

The Li_{2.6}Co_{0.4}N powders in Example 1 and Ketjen Black as a carbon material were mixed with a weight ratio of 95:5. The mixed powders were pressure-molded with a pressure of 2 tons/cm² to give a disk form having a diameter of 24 mm and a thickness of 0.7 mm, thereby obtaining an anode material mixture layer. A unit cell was formed in the same manner as Example 1, except that the anode material mixture layer thus obtained was used.

### EXAMPLE 3

The Li_{2.6}Co_{0.4}N powders in Example 1 and LiCl—KCl as a eutectic salt were mixed with a weight ratio of 95:5. The mixed powders were pressure-molded with a pressure of 2 tons/cm² to give a disk form having a diameter of 24 mm and a thickness of 0.7 mm, thereby obtaining an anode material mixture layer. A unit cell was formed in the same manner as Example 1, except that the anode material mixture layer thus obtained was used.

### EXAMPLE 4

The Li_{2.6}Co_{0.4}N powders in Example 1, Ketjen Black as a carbon material, and LiCl—KCl as a eutectic salt were mixed with a weight ratio of 90:5:5. The mixed powders were pressure-molded with a pressure of 2 tons/cm² to give a disk form having a diameter of 24 mm and a thickness of 0.7 mm, thereby obtaining an anode material mixture layer. A unit cell was formed in the same manner as Example 1, except that the anode material mixture layer thus obtained was used.

### EXAMPLE 5

Using Ni powders instead of Co powders, Li_{2.6}Ni_{0.4}N powders were prepared in the same manner as Example 1. A unit cell was prepared in the same manner as Example 1, except that Li_{2.6}Ni_{0.4}N powders thus obtained were used for an anode active material.

### EXAMPLE 6

A unit cell was prepared in the same manner as Example 4, except that Li_{2.6}Ni_{0.4}N powders of Example 5 were used instead of Li_{2.6}Co_{0.4}N powders of Example 1.

### EXAMPLE 7

Using Cu powders instead of Co powders, Li_{2.6}Cu_{0.4}N powders were prepared in the same manner as Example 1. A unit cell was prepared in the same manner as Example 1, except that Li_{2.6}Cu_{0.4}N powders thus obtained were used for an anode active material.

### EXAMPLE 8

A unit cell was prepared in the same manner as Example 4, except that Li_{2.6}Cu_{0.4}N powders of Example 7 were used instead of Li_{2.6}Co_{0.4}N powders of Example 1.

### EXAMPLE 9

Using Mn powders instead of Co powders, Li_{2.6}Mn_{0.4}N powders were prepared in the same manner as Example 1. A unit cell was prepared in the same manner as Example 1, except that Li_{2.6}Mn_{0.4}N powders thus obtained were used for an anode active material.

### EXAMPLE 10

A unit cell was prepared in the same manner as Example 4, except that Li_{2.6}Mn_{0.4}N powders of Example 9 were used instead of Li_{2.6}Co_{0.4}N powders of Example 1.

### EXAMPLE 11

Using Fe powders instead of Co powders, Li_{2.6}Fe_{0.4}N powders were prepared in the same manner as Example 1. A unit cell was prepared in the same manner as Example 1, except that Li_{2.6}Fe_{0.4}N powders thus obtained were used for an anode active material.

### EXAMPLE 12

A unit cell was prepared in the same manner as Example 4, except that Li_{2.6}Fe_{0.4}N powders of Example 11 were used instead of Li_{2.6}Co_{0.4}N powders of Example 1.

### EXAMPLES 13-16

Anode active material powders of Li₃₋ₓCoₓN (x=0.05, 0.1, 0.8, or 0.9) were obtained in the same manner as Example 1, except that Li₃N powders and Co powders were mixed so that the atomic ratio of Li and Co satisfies 3-x:x (x=0.05, 0.1, 0.8, or 0.9). Unit cells were respectively prepared by using the obtained anode active material powders in the same manner as Example 1.

### EXAMPLES 17-20

Anode active material powders of Li₃₋ₓNiₓN (x=0.05, 0.1, 0.8, or 0.9) were obtained in the same manner as Example 5, except that Li₃N powders and Ni powders were mixed so that the atomic ratio of Li and Ni satisfies 3-x:x (x=0.05, 0.1, 0.8, or 0.9). Unit cells were respectively prepared by using the obtained anode active material powders in the same manner as Example 1.

### EXAMPLES 21-24

Anode active material powders of Li₃₋ₓCuₓN (x=0.05, 0.1, 0.8, or 0.9) were obtained in the same manner as Example 7, except that Li₃N powders and Cu powders were mixed so that the atomic ratio of Li and Cu satisfies 3-x:x (x=0.05, 0.1, 0.8, or 0.9). Unit cells were respectively prepared by using the obtained anode active material powders in the same manner as Example 1.

### EXAMPLES 25-28

Anode active material powders of Li₃₋ₓMnₓN (x=0.05, 0.1, 0.8, or 0.9) were obtained in the same manner as Example 9, except that Li₃N powders and Mn powders were mixed so that the atomic ratio of Li and Mn satisfies 3-x:x (x=0.05, 0.1, 0.8, or 0.9). Unit cells were respectively prepared by using the obtained anode active material powders in the same manner as Example 1.

### EXAMPLES 29-32

Anode active material powders of Li₃₋ₓFeₓN (x=0.05, 0.1, 0.8, or 0.9) were obtained in the same manner as Example 11, except that Li₃N powders and Fe powders were mixed so that the atomic ratio of Li and Fe satisfies 3-x:x (x=0.05, 0.1, 0.8, or 0.9). Unit cells were respectively prepared by using the obtained anode active material powders in the same manner as Example 1.

### COMPARATIVE EXAMPLE 1

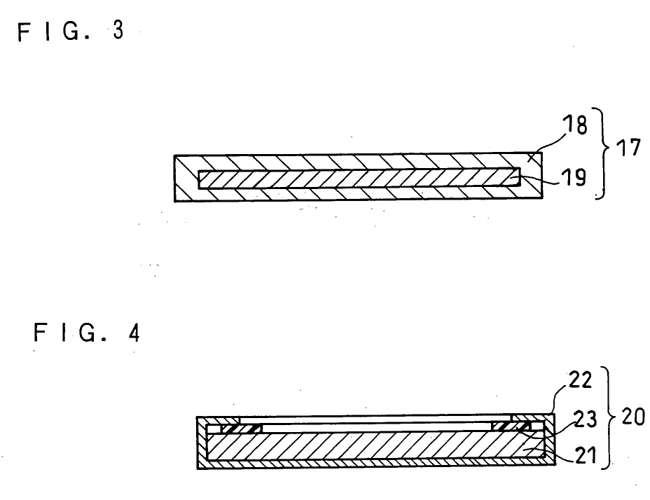

An anode 17 shown in FIG. 3 was prepared as described below.

On an iron layer 18 obtained by pressure-molding iron powders having an average particle size of 2 μm with a pressure of 0.5 ton/cm², a disk-like lithium metal foil 19 with a diameter of 24 mm was disposed. Further, on and around the lithium metal foil 19, iron powders were disposed and then molded with a pressure of 2 tons/cm² to give disk form with a diameter of 26 mm and a thickness of 1.2 mm. The anode 17 in which the lithium metal foil 19 was covered with the iron layer 18, as shown in FIG. 3, was thus obtained. The weight ratio of the lithium metal and iron was set to 20:80. A unit cell was prepared in the same manner as Example 1, except that the anode 17 thus obtained was used.

### COMPARATIVE EXAMPLE 2

A unit cell was prepared in the same manner as Comparative Example 1, except that the weight ratio of the lithium metal and iron powders was set to 35:65.

### COMPARATIVE EXAMPLE 3

A unit cell was prepared in the same manner as Comparative Example 1, except that the weight ratio of the lithium metal and iron powders was set to 3:97.

### COMPARATIVE EXAMPLE 4

An anode 20 shown in FIG. 4 was prepared as described below.

To a molten state lithium metal heated to a temperature of 300° C., iron powders with an average particle size of 2 μm were added and then homogenously mixed. The weight ratio of the lithium metal and the iron powders were set to 20:80 at this time. After this mixture was stretched to give a sheet-like shape and then cooled to give ambient temperature, the lithium metal foil was stamped into a disk shape, to obtain an anode material mixture layer 21 with a diameter of 24 mm and a thickness of 0.7 mm.

The anode material mixture layer 21 was placed into a cup-like current collector 22 made of SUS308, and an opening end of the current collector 22 were bent inwardly to crimp the peripheral portion of the anode material mixture layer 21, to fix the anode material mixture layer 21 in the current collector 22. At this time, a ring-like thermal insulator 23 was disposed between the peripheral portion of the anode material mixture layer 21 and the opening end of the current collector 22. The anode 20 with a diameter of 26 mm and a thickness of 1.2 mm was thus obtained.

A unit cell was prepared in the same manner as Example 1, except that the anode 20 thus obtained was used.

### COMPARATIVE EXAMPLE 5

A unit cell was prepared in the same manner as Comparative Example 4, except that the weight ratio of the lithium metal and the iron powders was set to 35:65.

### COMPARATIVE EXAMPLE 6

A unit cell was prepared in the same manner as Comparative Example 4, except that the weight ratio of the lithium metal and the iron powders was set to 10:90.

### COMPARATIVE EXAMPLE 7

Li—Al alloy powders (lithium content: 20 wt %) and aluminum metal powders were mixed with a weight ratio of 50:50. An anode material mixture layer was obtained in the same manner as Example 1, except that this mixture was used instead of Li_{2.6}C_{0.04}N powders. A unit cell was manufactured in the same manner as Example 1, except that this anode material mixture layer was used.

### COMPARATIVE EXAMPLE 8

A unit cell was manufactured in the same manner as Comparative Example 7, except that the weight ratio of the Li—Al alloy powders (lithium content: 20 wt %) and the aluminum metal powders were set to 80:20.

### COMPARATIVE EXAMPLE 9

A unit cell was manufactured in the same manner as Comparative Example 7, except that the weight ratio of the Li—Al alloy powders (lithium content: 20 wt %) and the aluminum metal powders were set to 20:80.

### COMPARATIVE EXAMPLE 10

Li—Al alloy powders (lithium content: 20 wt %) and LiCl—KCl as a eutectic salt were mixed with a weight ratio of 65:35. An anode material mixture layer was obtained in the same manner as Example 1, except that the mixture was used instead of Li_{2.6}C_{0.04}N powder. A unit cell was manufactured in the same manner as Example 1, except that this anode material mixture layer was used.

### COMPARATIVE EXAMPLE 11

A unit cell was manufactured in the same manner as Comparative Example 10, except that the weight ratio of the Li—Al alloy powders and the eutectic salt was set to 75:25.

### COMPARATIVE EXAMPLE 12

A unit cell was manufactured in the same manner as Comparative Example 10, except that the weight ratio of the Li—Al alloy powders and the eutectic salt was set to 55:45.

Following evaluations were carried out for each battery prepared in the above.

(3) Evaluations for Moldability of Anode Material Mixture Layer

Ten anodes were prepared for the anode in each Example and each Comparative Example, and occurrence of fracture and crack in the anode material mixture layer were checked visually.

(4) Evaluations for Discharge Characteristics of Battery

A test cell was formed by sandwiching a unit cell with two hot plates whose temperatures were controllable. Then, the test cell was discharged at a constant current, to check the discharge capacity of the unit cell.

For the discharge test, the unit cell was heated by the hot plate with a temperature of 500° C., which is an average operating temperature of a thermal battery in which LiCl—KCl was used as a eutectic salt, and then a constant current discharge test (end voltage: 0.4 V) was carried out at a relatively small current density of 0.5 A/cm².

Also, a constant current discharge test (end voltage: 0.4 V) was carried out at a large current density of 2 A/cm². At this time, the discharge tests were carried out by changing the heating temperatures with the hot plate to 450° C., 500° C., and 550° C., respectively.

Ten batteries were tested, respectively.

(5) Evaluations for Battery Reliability

Ten unit cells were prepared for the unit cell of each Example and each Comparative Example, and a constant current discharge (end voltage: 0.4 V) was carried out at a current density of 2 A/cm², while heating at 500° C., as in the above discharge test. Subsequently, presence or absence of leakage of lithium was checked visually for the anode in each unit cell.

The evaluation results are shown in Tables 1 and 2. The capacity at a 2 A/cm² discharge in Tables 1 and 2 is shown as a relative value (index) setting the capacity value at the above 0.5 A/cm² discharge as 100.

TABLE 1

| | | | Capacity at 2 A/cm² | | |
|---|---|---|---|---|---|
| | | | Discharge (index) | | |
| | Material for Anode | Capacity | Heated | Heated | Heated |
| | Material Mixture | at 0.5 A/cm² | to | to | to |
| | Layer | Discharge (As) | 450° C. | 500° C. | 550° C. |
| Ex. 1 | Li_{2.6}Co_{0.4}N | 574 | 93 | 94 | 96 |
| Ex. 2 | Li_{2.6}Co_{0.4}N + C | 607 | 95 | 97 | 98 |
| Ex. 3 | Li_{2.6}Co_{0.4}N + Eutectic | 618 | 96 | 98 | 99 |
| | Salt | | | | |
| Ex. 4 | Li_{2.6}Co_{0.4}N + C + Eutectic | 614 | 97 | 98 | 99 |
| | Salt | | | | |
| Ex. 5 | Li_{2.6}Ni_{0.4}N | 566 | 90 | 91 | 94 |
| Ex. 6 | Li_{2.6}Ni_{0.4}N + C + Eutectic | 588 | 91 | 93 | 96 |
| | Salt | | | | |
| Ex. 7 | Li_{2.6}Cu_{0.4}N | 558 | 91 | 92 | 93 |
| Ex. 8 | Li_{2.6}Cu_{0.4}N + C + Eutectic | 585 | 92 | 95 | 97 |
| | Salt | | | | |
| Ex. 9 | Li_{2.6}Mn_{0.4}N | 562 | 91 | 92 | 93 |
| Ex. 10 | Li_{2.6}Mn_{0.4}N + C + Eutectic | 584 | 92 | 94 | 96 |
| | Salt | | | | |
| Ex. 11 | Li_{2.6}Fe_{0.4}N | 570 | 91 | 92 | 93 |
| Ex. 12 | Li_{2.6}Fe_{0.4}N + C + Eutectic | 586 | 92 | 93 | 95 |
| | Salt | | | | |
| Ex. 13 | Li_{2.95}Co_{0.05}N | 578 | 92 | 93 | 94 |
| Ex. 14 | Li_{2.9}Co_{0.1}N | 584 | 92 | 93 | 94 |
| Ex. 15 | Li_{2.2}Co_{0.8}N | 563 | 92 | 93 | 95 |
| Ex. 16 | Li_{2.1}Co_{0.9}N | 555 | 92 | 93 | 94 |
| Ex. 17 | Li_{2.95}Ni_{0.05}N | 579 | 91 | 92 | 93 |
| Ex. 18 | Li_{2.9}Ni_{0.1}N | 588 | 92 | 93 | 94 |
| Ex. 19 | Li_{2.2}Ni_{0.8}N | 542 | 91 | 92 | 94 |
| Ex. 20 | Li_{2.1}Ni_{0.9}N | 538 | 91 | 92 | 93 |
| Ex. 21 | Li_{2.95}Cu_{0.05}N | 574 | 92 | 92 | 93 |
| Ex. 22 | Li_{2.9}Cu_{0.1}N | 580 | 92 | 93 | 94 |
| Ex. 23 | Li_{2.2}Cu_{0.8}N | 544 | 91 | 92 | 93 |
| Ex. 24 | Li_{2.1}Cu_{0.9}N | 535 | 90 | 91 | 93 |
| Ex. 25 | Li_{2.95}Mn_{0.05}N | 563 | 90 | 93 | 94 |
| Ex. 26 | Li_{2.9}Mn_{0.1}N | 568 | 92 | 93 | 94 |
| Ex. 27 | Li_{2.2}Mn_{0.8}N | 551 | 92 | 93 | 94 |
| Ex. 28 | Li_{2.1}Mn_{0.9}N | 548 | 92 | 92 | 93 |
| Ex. 29 | Li_{2.95}Fe_{0.05}N | 568 | 91 | 92 | 93 |
| Ex. 30 | Li_{2.9}Fe_{0.1}N | 574 | 92 | 93 | 94 |
| Ex. 31 | Li_{2.2}Fe_{0.8}N | 544 | 91 | 92 | 93 |
| Ex. 32 | Li_{2.1}Fe_{0.9}N | 539 | 90 | 91 | 92 |

TABLE 2

| | | Number of | | | Capacity at | | |
|---|---|---|---|---|---|---|---|
| | | Anode in which | | | 2 A/cm² | | |
| | | Defects Occurred | | | Discharge | | |
| | | (pieces) | | | (index) | | |
| | Material for | | Leakage | Capacity | | | |
| | Anode | Fractures | of | at 0.5 A/cm² | Heated | Heated | Heated |
| | Material | and | Lithium | Discharge | to | to | to |
| | Mixture Layer | Cracks | Metal | (As) | 450° C. | 500° C. | 550° C. |
| Comp. Ex. 1 | Li + Fe = 20:80 | 0 | 0 | 555 | 78 | 84 | 90 |
| Comp. Ex. 2 | Li + Fe = 35:65 | 1 | 4 | — | — | — | — |
| Comp. Ex. 3 | Li:Fe = 3:97 | 0 | 0 | 82 | 77 | 83 | 91 |
| Comp. Ex. 4 | Li + Fe = 20:80 | 0 | 0 | 582 | 67 | 81 | 84 |
| Comp. Ex. 5 | Li + Fe = 35:65 | 2 | 6 | — | — | — | — |
| Comp. Ex. 6 | Li:Fe = 10:90 | 0 | 0 | 286 | 76 | 80 | 83 |
| Comp. Ex. 7 | LiAl:Al = 50:50 | 0 | — | 240 | 69 | 76 | 80 |
| Comp. Ex. 8 | LiAl:Al = 80:20 | 4 | — | — | — | — | — |
| Comp. Ex. 9 | LiAl:Al = 20:80 | 0 | — | 53 | 71 | 79 | 85 |
| Comp. Ex. | LiAl:Eutectic | 0 | — | 309 | 68 | 75 | 84 |
| 10 | Salt = 65:35 | | | | | | |
| Comp. Ex. | LiAl:Eutectic | 3 | — | — | — | — | — |
| 11 | Salt = 75:25 | | | | | | |
| Comp. Ex. | LiAl:Eutectic | 0 | — | 340 | 68 | 76 | 80 |
| 12 | Salt = 55:45 | | | | | | |

Without fractures and cracks in any of the anode material mixture layers of the anodes in Examples 1 to 32, no defect due to moldability could be found. No deterioration in the moldability of anode material mixture layer occurred, even in the case when a conductive material such as carbon, and a eutectic salt were added to the anode material mixture layer. No lithium leakage was found in the unit cells of Examples 1 to 32.

On the other hand, as shown in Table 2, in Comparative Examples 2, 5, 8, and 11, in which the lithium content in anode is large, fractures and cracks occurred in some anodes, and the moldability of anode material mixture layer deteriorated.

Also, as shown in Table 2, in Comparative Examples 2 and 5, in addition to the above defects, due to the increased ratio of iron powders used as a retainer relative to lithium metal, retainer was disabled to bind lithium metal at the discharge at high temperatures, thereby causing a partial leakage of lithium metal to the outside in some anodes. The lithium metal leaked outside may cause a short circuit by contacting with a cathode.

As shown in Tables 1 and 2, at a low-load discharge with a current density of 0.5 A/cm², the unit cells in Examples 1 to 32 showed the capacity same as or more than the unit cells in Comparative Examples 1 to 12.

Additionally, the unit cells in Examples 2 to 4 showed an increased capacity compared with the unit cell in Example 1.

The reasons for the increased capacity may be as in the following. In the battery of Example 2, due to the addition of carbon, the contact resistance between the particles of Li_{2.6}Co_{0.4}N powders decreased, and the electron conductivity of the anode material mixture layer improved. In the battery of Example 3, due to the addition of the eutectic salt, ion conductivity of the anode material mixture layer improved. In the battery of Example 4, the effects due to the addition of carbon and eutectic salt in the above were exerted, and availability of the anode material mixture layer improved.

Additionally, in the unit cells of Examples 6, 8, 10, and 12, capacity increased compared with the unit cells of Examples 5, 7, 9, and 11, respectively.

In the unit cell of Comparative Examples 1, 3, 4, and 6, in which the lithium metal is used for the anode active material, iron powders were added as a retainer, to improve binding ability for the lithium metal. However, the amount of the lithium metal decreased by the amount of the retainer added, and the capacity exceeding the cells of Examples 1 to 32 could not be obtained.

In the unit cells of Comparative Examples 7 and 9, in which the Li—Al alloy was used for the anode active material, Al powders were added to improve moldability of the anode material mixture layer. However, the amount of Li—Al alloy decreased by the amount of the Al powders added, thereby decreasing the capacity.

In the unit cells of Comparative Examples 10 and 12, in which the Li—Al alloy was used for the anode active material, a eutectic salt was added to improve reactivity of the anode material mixture layer. However, the amount of the Li—Al alloy decreased by the amount of the eutectic salt added, thereby decreasing the capacity.

At a high-load discharge with the current density of 2 A/cm², in batteries of Examples 1 to 32, a high capacity of 90 or more was obtained at any operating temperatures, showing more excellent discharge characteristics under high load than the unit cells of Comparative Examples 1, 3, 4, 6, 7, 9, 10, and 12. Especially, in the unit cells of Examples 2 to 4, 6, 8, 10, and 12, more excellent discharge characteristics under high load were obtained than the unit cells of Examples 1, 5, 7, 9, and 11.

In Examples 1 to 4, in which the element M of the lithium-containing composite nitride was Co, specifically excellent discharge characteristics were obtained.

Although the case where y=0 in Li_{3-x-y}MₓN was shown in the above Example, when “y” is in the range of 0 to 2-x, excellent discharge characteristics can be obtained when “x” is in the range of 0.1 to 0.8, as in the above Example.

### EXAMPLES 33 to 43

In Examples herein, powders of the anode active material were prepared in the same manner as Example 1, except that in Li_{3-x-y}MₓN, M is set to Co, and the mixing ratio of Li₃N powders and Co powders were changed so that values of “x” and “y” satisfy the value shown in Table 3. Then, by using the anode active material shown in Table 3, unit cells were made in the same manner as Example 1, and the same evaluations for discharge characteristics as in the above were conducted. The results are shown in Table 3.

TABLE 3

| | Anode | | | Capacity at 2 A/cm² | | |
|---|---|---|---|---|---|---|
| | Active | | Capacity at | Discharge (index) | | |
| | Material: | | 0.5 A/cm² | Heated | Heated | Heated |
| | Li_{3-x-y}CoₓN | | Discharge | to | to | to |
| | x | y | (As) | 450° C. | 500° C. | 550° C. |
| Ex. 33 | 0.1 | 1.9 | 399 | 91 | 93 | 94 |
| Ex. 34 | 0.1 | 1.4 | 484 | 91 | 93 | 93 |
| Ex. 35 | 0.1 | 0.9 | 541 | 92 | 93 | 94 |
| Ex. 36 | 0.1 | 0.4 | 582 | 92 | 94 | 95 |
| Ex. 37 | 0.4 | 1.6 | 353 | 92 | 93 | 94 |
| Ex. 38 | 0.4 | 1.1 | 438 | 92 | 93 | 94 |
| Ex. 39 | 0.4 | 0.6 | 498 | 93 | 94 | 95 |
| Ex. 40 | 0.4 | 0.1 | 543 | 93 | 94 | 95 |
| Ex. 41 | 0.8 | 1.2 | 306 | 92 | 93 | 94 |
| Ex. 42 | 0.8 | 0.7 | 389 | 92 | 93 | 94 |
| Ex. 43 | 0.8 | 0.2 | 451 | 93 | 94 | 95 |

The unit cells of Examples 33 to 43 showed a high capacity of 90 or more at a high-load discharge with a current density of 2 A/cm², in respective operating temperatures. Based on such results, it was revealed that when “x” is in the range of 0.1 to 0.8, excellent discharge characteristics at high load can be obtained when “y” is in the range of 0 to 2-x.

In these Examples, although the case when the element M was Co was shown, the same effects with these Examples can be obtained as well when the element M is Ni, Cu, Mn, or Fe.

### EXAMPLE 44

A thermal battery having the same structure with the above FIG. 1 was prepared by using the unit cell in Example 1. Preparation of the thermal battery was carried out in an environment of dry air with the dew point of −45° C. or below, where influences from moisture were eliminated to the maximum. Also, when handling the lithium-containing composite nitride, the preparation was carried out under a high-purity nitrogen atmosphere (99.9% or more), as necessary.

The unit cell 7 and a heating agent 5 were stacked alternately to form a power-generating portion. At this time, 13 unit cells 7 were used. For the heating agent 5, a mixture of Fe and KClO₄ was used, and the mixture ratio was adjusted so that an average temperature during the operation of the battery becomes 500° C.

An ignition pad 4 was disposed on top of the power-generating portion, and the circumference of the power-generating portion was covered by a fuse wrap 6. For the ignition pad 4 and the fuse wrap 6, a mixture of Zr, BaCrO₄, and a glass fiber were used.

For an ignition material of the igniter 3, a mixture in which potassium nitrate, sulfur, and carbon are mixed with a weight ratio of 75:10:15 was used. For insulating materials 9a and 9b, a ceramic fiber material which used silica and alumina as main components was used.

A thermal battery whose operating temperature was 500° C. was thus obtained.

### EXAMPLE 45

A thermal battery was prepared in the same manner as Example 44, except that the unit cell of Example 5 was used instead of the unit cell of Example 1.

### EXAMPLE 46

A thermal battery was prepared in the same manner as Example 44, except that the unit cell of Example 7 was used instead of the unit cell of Example 1.

For the thermal batteries of Examples 44 to 46, a discharge test was carried out as in the following. A high voltage was applied from a power source connected to an ignition terminal to fire an igniter, thereby activating the thermal battery. Then, the thermal battery was discharged at a current density of 0.5 A/cm² (end voltage: 7.8 V) or 2 A/cm² (end voltage: 6.5 V).

As a result, it was confirmed that in the thermal battery in which a plurality of unit cells were stacked, the same capacity with the unit cell can be obtained as well.

In the above Examples, in the anode material mixture layer, the amount of the conductive material to be added was set to 5 wt %, and the amount of the eutectic salt to be added was set to 5 wt %, although the amount to be added is not limited particularly. Although the performance can be exerted sufficiently without these additives, to improve battery performance further, these additives can be included as appropriate.

Although a disk-shaped anode with a diameter of 26 mm comprising a disk-shaped anode material mixture layer housed in a bottomed, cylindrical cup made of metal was used in the above Examples, scale, shape, and material are not to be limited particularly, as long as performance as an anode can be brought out. For example, a donut-shape with a hole in the center, semi-circle, square, and the like may be used.

Additionally, although the preparation of the unit cell was carried out under a nitrogen atmosphere in the above Example, the preparation may be carried out in an argon atmosphere.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A thermal battery including a plurality of unit cells, each unit cell comprising:
a cathode,
an anode, and
an electrolyte disposed between said cathode and said anode, said electrolyte comprising a salt molten at the thermal battery operating temperatures,
wherein said anode comprises a lithium-containing composite nitride as an active material.

2. The thermal battery in accordance with claim 1, wherein said lithium-containing composite nitride is a compound represented by the general formula:
Li_{3-x-y}MₓN,
where M is at least one selected from the group consisting of Co, Ni, Cu, Mn, and Fe, and
x and y satisfy 0.1≦x≦0.8 and 0≦y≦2-x, respectively.

3. The thermal battery in accordance with claim 1, wherein said anode further includes at least one selected from the group consisting of iron, copper, nickel, manganese, and a carbon material.

4. The thermal battery in accordance with claim 1, wherein said anode further includes a salt molten at the thermal battery operating temperatures.
